(19) United States
(12) Patent Application Publication
(10) Pub. No.: US 2026/0210719 A1
(43) Pub. Date: Jul. 23, 2026

(54) SYSTEMS AND METHODS FOR REMOTE NAVIGATION

(71) Applicant: Honeywell International Inc., Charlotte, NC (US)

(72) Inventors: Vibhor L. Bageshwar, Rosemount, MN (US); Karl Roenigk, Ellicott City, MD (US)

(73) Assignee: Honeywell International Inc., Charlotte, NC (US)

(21) Appl. No.: 19/269,289

(22) Filed: Jul. 15, 2025

Related U.S. Application Data
(60) Provisional application No. 63/746,981, filed on Jan. 18, 2025.

(51) Int. Cl. G01C 21/16; G01C 21/00

(52) U.S. Cl. CPC G01C 21/165; G01C 21/3848

(57) ABSTRACT

A system comprises aiding sensors onboard a vehicle, an onboard IMU that produces inertial measurements, a strapdown INS that receives the inertial measurements; and a processor coupled to the aiding sensors and strapdown INS. The processor hosts a feature extraction module, an association module, and a map features module. An onboard navigation filter is in communication with the association module and strapdown INS. An onboard transmitter/receiver is in communication with the strapdown INS. The feature extraction module extracts sensor-based features from sensor measurements provided by the aiding sensors. The map features module stores map-based features of a local map received by the vehicle from a remote command center. The association module associates the sensor-based features with the map-based features to identify position vectors in the local map that are sent to the navigation filter for further processing to provide aided navigation of the vehicle.

### CROSS REFERENCE TO RELATED APPLICATION

This application claims the benefit of and priority to U.S. Provisional Application No. 63/746,981, filed on Jan. 18, 2025, the disclosure of which is herein incorporated by reference.

### BACKGROUND

Vehicle operations often occur in Global Navigation Satellite System (GNSS) denied environments. Thus, vehicle navigation systems typically use various aiding sensors to aid onboard inertial measurement units (IMUs) during GNSS denied scenarios. The aiding sensors typically measure features or feature gradients of the operating environment of a vehicle. Vehicle navigation systems utilize maps of the operating environment to associate measured features with map-based features to compute a navigation solution for the vehicle.

Various vehicles may not have onboard maps for use in GNSS denied navigation systems. For example, small vehicles such as uncrewed aircraft vehicles often have insufficient onboard memory to store a map for navigation. In addition, a map may be proprietary, or not available prior to a vehicle launch.

### SUMMARY

A system comprises one or more aiding sensors onboard a vehicle; an inertial measurement unit (IMU) onboard the vehicle and operative to produce inertial measurements; a strapdown inertial navigation system (INS) onboard the vehicle and configured to receive the inertial measurements from the IMU, the strapdown INS configured to compute estimated kinematic state statistics of the vehicle; and at least one processor operatively coupled to the one or more aiding sensors and the strapdown INS. The at least one processor hosts a feature extraction module, an association module in operative communication with the feature extraction module, and a map features module in operative communication with the association module. An onboard navigation filter is in operative communication with the association module and the strapdown INS. An onboard transmitter/receiver is in operative communication with the strapdown INS. The feature extraction module is operative to extract sensor-based features from sensor measurements provided by the one or more aiding sensors. The map features module is operative to store map-based features of a local map received by the vehicle from a remote command center. The association module is operative to associate the sensor-based features from the feature extraction module with the map-based features from the map features module to identify position vectors in the local map that are sent to the navigation filter for further processing to provide aided navigation of the vehicle.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system for remote navigation of a vehicle, according to one embodiment;

FIG. 2 is a vector diagram showing a schematic representation of reference frames that can be used for remote navigation of a vehicle, according to one embodiment;

FIG. 3 is a functional block diagram of a vehicle navigation filter that can be used in a remote navigation system, according to one embodiment; and

FIG. 4 is a flow diagram of a method for remote navigation of a vehicle, according to one example implementation.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A system and method for remote navigation of a vehicle are described herein. In general, the present system and method provide for vehicle navigation in GNSS denied environments, with onboard aiding sensors used in conjunction with offboard maps. The offboard maps are located at a remote location such as a command center, which can select and transmit local maps to the vehicle that are valid for a user-specified time and distance. Examples of remote locations for the command center include an air traffic control system, an uncrewed air traffic management system, a ground station, a high-altitude aircraft, a marine surface vessel, an Earth satellite, and the like. In addition, the command center can be in communication with multiple vehicles. Maps of a vehicle's operating environment and for use by an onboard vehicle navigation system are stored and available at the command center.

The vehicles that can use the present remote navigation system include vehicles of any size. Examples of such vehicles include uncrewed aircraft systems (UAS), including UAS groups 1-5, crewed aircraft, ground vehicles, underground vehicles, water vehicles (e.g., ships), underwater vehicles (e.g., submarines), spacecraft, vehicles operating in single or multiple environments with different types of terrain, and the like.

The aiding sensors measure features or feature gradients of the vehicle's operating environment. The vehicle navigation system is a map-based, navigation system that uses a local map of the operating environment, provided by the command center, to associate measured features with map features to compute a navigation solution including estimated vehicle kinematic state statistics.

The command center is remotely located from the operational environment of the vehicle, so communications between the command center and vehicle occur at a slower rate than the aiding sensor measurement frequency. The vehicle transmits its estimated kinematic state solution to the command center at user-specified navigation time intervals referred to as a navigation time period. The command center predicts the vehicle position and angular orientation for a user-selected map validity time and transmits a corresponding map to the vehicle. The vehicle navigation filter uses this map, which is valid from the communication time to the map validity time. The vehicle can delete old maps since the command center transmits an updated map once during every navigation time period. These time periods can be fixed or changed with time as dictated by the vehicle's operational scenario.

Further details of various embodiments are described hereafter with reference to the drawings.

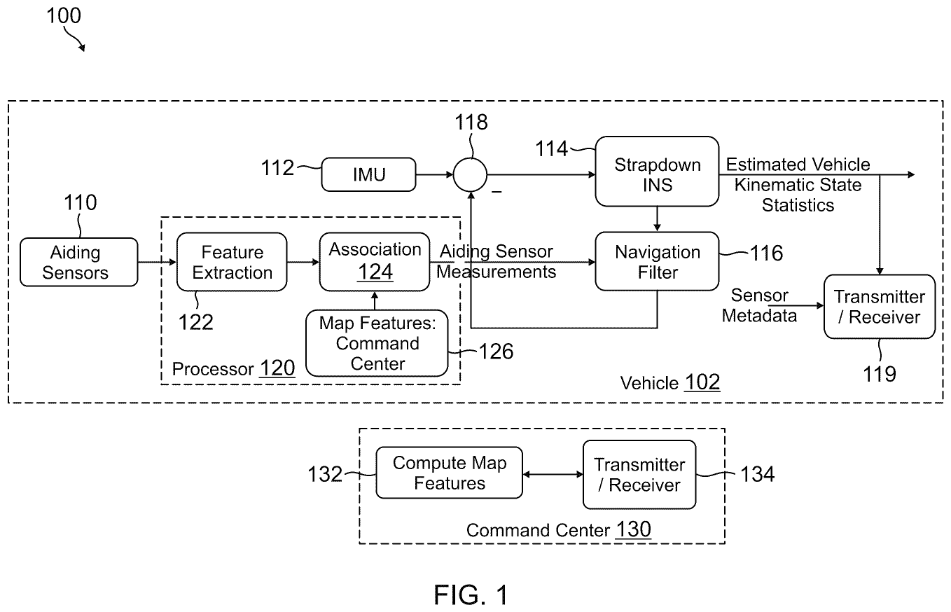

FIG. 1 is a block diagram of a system 100 for remote navigation of a vehicle 102, according to one embodiment. The system 100 generally comprises one or more aiding sensors 110 onboard the vehicle 102 that are operative to provide various sensor measurements; an onboard inertial measurement unit (IMU) 112 operative to produce inertial measurements for the vehicle 102; and a strapdown inertial navigation system (INS) 114 onboard the vehicle 102 that is configured to receive the inertial measurements from the IMU 112. The aiding sensors 110 can include cameras, light detection and ranging (LiDAR) devices, radars, acoustic sensors, magnetometers, gravitometers, radar altimeters, star trackers, combinations thereof, and the like.

A navigation filter 116 is in operative communication with the strapdown INS 114. The strapdown INS 114 is configured to compute estimated kinematic state statistics (position, velocity, and angular orientation) of the vehicle 102, based on the inertial measurements from the IMU 112, which is combined with output data from the navigation filter 116 using a subtractor 118. The navigation filter 116 can be a Bayesian filter or the like. In addition, an onboard transmitter/receiver 119 is in operative communication with the strapdown INS 114.

At least one processor 120 is operatively coupled with the aiding sensors 110 and the navigation filter 116. The processor 120 hosts a feature extraction module 122, an association module 124 in operative communication with the feature extraction module 122, and a map features module 126 in operative communication with the association module 124. The strapdown INS 114 and the navigation filter 116 are also hosted in a processor, which can be the processor 120 or a different processor.

The feature extraction module 122 is operative to extract sensor-based features from sensor measurements provided by the aiding sensors 110. The map features module 126 is operative to store map-based features of a local map received by the vehicle 102 from a remote command center 130, which is described in further detail hereafter. The association module 124 is operative to associate the sensor-based features from the feature extraction module 122 with the map-based features from the map features module 126, to identify vehicle positions and angular orientations relative to the local map that are sent to the navigation filter 116 for further processing, and to provide aided navigation of the vehicle 102.

The sensor-based features can be extracted from sensor measurements by various feature extraction methods known to those skilled in the art. The sensor measurements can be various combinations of position, range, bearing angle, and elevation angle to the features, represented by: r_{v,f,im}∀i=1, . . . , I where I≡number of in-view features. The sensor-based features can be associated with the map-based features to determine vehicle positions and angular orientations relative to the local map, by using various association methods known to those skilled in the art.

The system 100 can also incorporate past or delayed sensor measurements. There are various methods of incorporating such past or delayed measurements known to those skilled in the art. For example, in one selected approach, a state vector is augmented with past, or delayed states, to incorporate delayed measurements.

The command center 130 includes a processing unit 132 that is operative to compute map-based features based on one or more maps stored in a local database, and periodic information received from the vehicle 102. A local transmitter/receiver 134 is in operative communication with the processing unit 132. The command center 130 is configured to communicate with the vehicle 102 through the local transmitter/receiver 134, which communicates with the onboard transmitter/receiver 119. The periodic information received from the vehicle 102 includes the estimated kinematic state statistics of the vehicle 102, and sensor metadata such as sensor field of view, reference frame, units, and measurement frequency included in the sensor metadata from the aiding sensors 110.

The processing unit 132 in the command center 130 is operative to predict a trajectory of the vehicle 102 forward in time to a map validity time using a computation time of the estimated kinematics state statistics as an initial time. If a sensor field of view is provided in the sensor metadata, then feature position vectors within the sensor field of view are selected for each computed location and angular orientation and their error statistics in the predicted trajectory. If a sensor field of view is not provided in the sensor metadata, then a spherical field of view is chosen with a user selected radius, to select feature position vectors for each computed location and angular orientation and their error statistics in the predicted trajectory. The processing unit 132 removes duplicate features from the set of features collected from the predicted trajectory when completed, and provides a local map that encompasses the predicted trajectory for transmission to the vehicle 102 by the local transmitter/receiver 134.

During operation of the system 100, the vehicle 102 transmits its estimated kinematic state statistics to the command center 130. This transmission occurs once every user-specified time period (navigation time period). The navigation time period is longer than the aiding sensor measurement frequency. The selection of the navigation time period minimizes communications between the vehicle 102 and the command center 130.

There are communication time delays during information transmission between the vehicle 102 and the command center 130. A communication time delay can result in the vehicle 102 potentially being at a different location with a different angular orientation than when the estimated vehicle kinematic state solution is transmitted to the command center by the vehicle transmitter/receiver 119 and when a local map is received from the command center 130. One result of this situation is that the aiding sensors 110 may currently have a different field of view of the environment because of motion and rotation of the vehicle 102. In addition, a map validity time can be affected.

Thus, the command center 130 can transmit a local map to the vehicle 102 that includes map features that are valid at the transmission time of the vehicle's navigation solution and has feature positions for the projected vehicle position vector for a user-specified map validity time that is longer than the navigation time period and communication time delay. The navigation filter 116 uses the local map that is valid from the communication time to the map validity time. Older maps are deleted in the vehicle 102 since the command center 130 transmits an updated map once during every navigation time period to minimize usage of vehicle memory storage.

The present system and method are described in additional detail in the following sections.

### Reference Frames

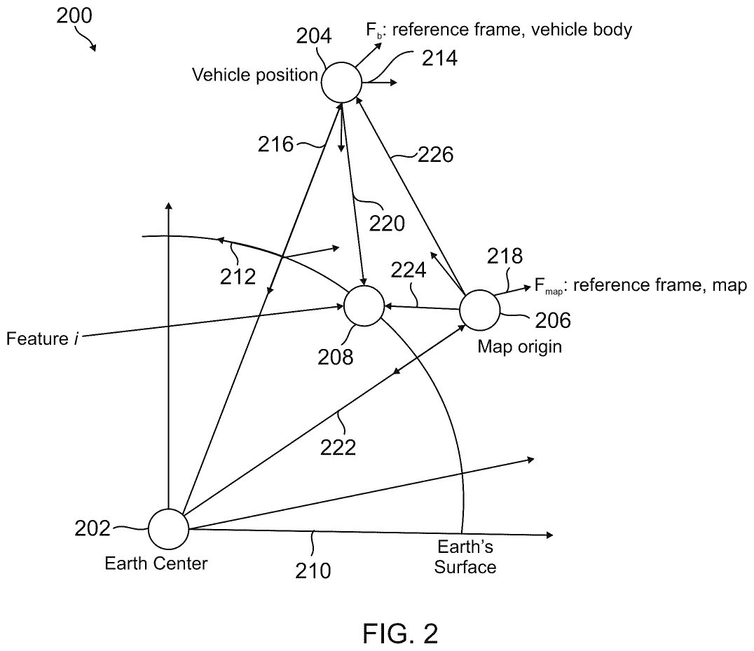

FIG. 2 is a vector diagram 200 showing a schematic representation of reference frames used for remote navigation of a vehicle, according to one example. The vector diagram 200 is depicted with respect to Earth center 202, a vehicle position 204, a map origin 206, and a map feature 208 (feature i). An Earth Centered, Earth fixed reference frame, F_{ECEF}, is represented at 210. A North East Down reference frame, F_{NED}, is represented at 212. A vehicle reference body frame (F_{b}: reference frame, vehicle body) is represented at 214. A vehicle position vector, \vec{p}^{E}, is represented by a vector 216. A reference map frame (Fₘₐₚ: reference frame, map) is represented at 218. A vehicle position vector relative to feature i, \vec{r}_{v,f,i}, is represented by a vector 220. A map position vector, \vec{r}ₘₐₚ, is represented by a vector 222. A feature i position vector, \vec{r}_{map,f,i}, is represented by a vector 224. A vehicle position vector, \vec{r}_{v,map}, is represented by a vector 226. The feature i depends on the type of aiding sensor and feature map that are used.

In the vector diagram 200:

$${\vec{r}}_{v , m a p} = - {\vec{r}}_{v , f , i} + {\vec{r}}_{m a p , f , i}$$

$${\vec{p}}^{E} = {\vec{r}}_{v , m a p} + {\vec{r}}_{m a p} = - {\vec{r}}_{v / g b} + {\vec{r}}_{gb , Lz} + {\vec{r}}_{L z} .$$

### Strapdown Inertial Navigation System

Further details related to the strapdown INS that can be used in the present remote navigation system and method are described as follows.

### Strapdown INS Equations

The mechanization equations utilized by the strapdown INS in the present navigation system are listed below. These equations govern vehicle motion forward in time.

$${\dot{p}}^{E} = T {v}^{N}$$

$${\dot{v}}^{N} = {C}_{N b} {f}^{b} - [ ( 2 {ω}_{E / I}^{N} + {ω}_{N / E}^{N} ) \times ] {v}^{N} + {g}^{N}$$

$${\dot{C}}_{N b} = {C}_{N b} [ ( {ω}_{b / I}^{b} ) \times - ( {ω}_{N / I}^{b} ) \times ]$$

$$T = [ \begin{matrix}\frac{1}{{R}_{N} + h} & 0 & 0 \\ 0 & \frac{1}{( {R}_{E} + h ) cos L} & 0 \\ 0 & 0 & - 1\end{matrix} ]$$

$${p}^{E} = [ \begin{matrix}L \\ λ \\ h\end{matrix} ] ≡ [ \begin{matrix}latitude \\ l o n g i t u d e \\ a l t i t u d e\end{matrix} ]$$

where:

$${ω}_{A / B}^{C} ≡ angular velocity of {F}_{A} relative {F}_{B} resolved in {F}_{C}$$

$$( ∘ ) \times ≡ skew - symmetric matrix$$

T═transforms velocity vector resolved in F_{NED} to geodetic reference frame
   v^{N}≡velocity vector resolved in F_{NED}
   g^{N}≡gravity vector resolved in F_{NED}
   C_{AB}≡Direction Cosine Matrix, F_{B} to FdA
   R_{N}≡North/South (meridian) Earth radii
   R_{E}≡East/West (prime vertical) Earth radii.

### Attitude Update Equations

The update equations utilized to govern vehicle angular orientation (attitude) forward in time are listed as follows.

$${Ψ}_{b / N} = [ \begin{matrix}ϕ \\ θ \\ ψψ\end{matrix} ] ≡ [ \begin{matrix}roll angle \\ pitch angle \\ heading angle\end{matrix} ]$$

$${\dot{Ψ}}_{b / N} = F ( {Ψ}_{b / N} ) {ω}_{b / N}^{b}$$

$$F ( {Ψ}_{b / N} ) = \frac{1}{cos θ} [ \begin{matrix}1 & sin ϕ sin θ & cos ϕ cos θ \\ 0 & cos ϕ cos θ & - sin ϕ sin θ \\ 0 & sin ϕ & cos ϕ\end{matrix} ]$$

$${ω}_{b / N}^{b} = {ω}_{b / i}^{b} - {ω}_{N / i}^{b}$$

$${ω}_{b / i}^{b} ≡ rate gyro measurements$$

$${ω}_{N / i}^{b} ≡ transport rate$$

$${[ \begin{matrix}ϕ \\ θ \\ ψ\end{matrix} ]}_{k + 1} = {[ \begin{matrix}ϕ \\ θ \\ ψ\end{matrix} ]}_{k} + τ F ( {Ψ}_{b / N} ( {t}_{k} ) ) {ω}_{b / N}^{b} ( {t}_{k} )$$

$$τ = {t}_{k + 1} - {t}_{k} .$$

### Velocity Update Equations

The update equations utilized to govern vehicle velocity forward in time are listed as follows.

$${v}_{k + 1}^{N} = {v}_{k + 1}^{N} + τ {\dot{v}}^{N}$$

$${\dot{v}}^{N} = {C}_{N b} {f}^{b} - [ ( 2 {ω}_{E / I}^{N} + {ω}_{N / E}^{N} ) \times ] {v}^{N} + {g}^{N}$$

$$τ = {t}_{k + 1} - {t}_{k}$$

C_{Nb}f^{b}=specific force measurements resolved in F_{NED}

$$[ ( 2 {ω}_{E / I}^{N} + {ω}_{N / E}^{N} ) \times ] {v}^{N} ≡ correction for coriolis acceleration$$

$${ω}_{E / I}^{N} {\vert}_{k} ≡ Earth rate resolved in {F}_{NED} = 7.292115 {e}^{- 5} [ \begin{matrix}cos {L}_{k} \\ 0 \\ - sin {L}_{k}\end{matrix} ] rad / s$$

$${ω}_{N / E}^{N} {\vert}_{k} ≡ transport rate resolved in {F}_{N E D} = {[ \frac{{v}_{E}}{{R}_{E} + h} {\vert}_{k} - \frac{{v}_{N}}{{R}_{N} + h} {\vert}_{k} - \frac{{v}_{E} tan L}{{R}_{E} + h} {\vert}_{k} ]}^{T}$$

### Position Update Equations

The update equations utilized to determine vehicle position forward in time are listed as follows.

$${L}_{k + 1} = {L}_{k} + τ \frac{{v}_{N}}{{R}_{N} + h} {\vert}_{k}$$

$${λ}_{k + 1} = {λ}_{k} + τ \frac{{v}_{E}}{( {R}_{E} + h ) cos L} {\vert}_{k}$$

$${h}_{k + 1} = {h}_{k} - τ {v}_{D} {\vert}_{k}$$

$$τ = {t}_{k + 1} - {t}_{k} .$$

### Strapdown INS Error Models

The equations utilized in strapdown INS error models for the present navigation system are listed as follows.

$$δ \dot{p} = {T}^{′} {δp}^{N} + T δ {v}^{N}$$

$$δ {\dot{v}}^{N} = [ ( {C}_{N b} {f}^{b} ) \times ] δ {Ψ}_{b / N}^{N} + {C}_{N b} δ {f}^{b} - [ ( 2 {ω}_{E / I}^{N} + {ω}_{N / E}^{N} ) \times ] δ {v}^{N} - [ ( 2 δ {ω}_{E / I}^{N} + δ {ω}_{N / E}^{N} ) \times ] {v}^{N} + δ {g}^{N}$$

$$δ {\dot{Ψ}}_{b / N}^{N} = - [ {ω}_{N / I}^{N} \times ] δ {Ψ}_{b / N}^{N} + δ {ω}_{N / I}^{N} - {C}_{N b} δ {ω}_{b / I}^{b}$$

where:
T′=transforms position errors to their time derivatives

$$δ {\dot{Ψ}}_{b / N}^{N} ≡ 3 D attitude errors resolved in {F}_{NED} .$$

$${f}^{b} = ( I + {M}_{a} ) {f}_{{t}^{}}^{b} + {b}_{a}^{b} + {w}_{a}^{b}$$

$${ω}_{b / I}^{b} = ( I + {M}_{g} ) {ω}_{b / It}^{b} + {b}_{g}^{b} + {w}_{g}^{b}$$

$${b}_{( \cdot )}^{b} = {b}_{( \cdot ) 0}^{b} + {b}_{( \cdot ) s}^{b}$$

$${\dot{b}}_{( \cdot ) s}^{b} = - \frac{1}{{τ}_{( \cdot )}} {I}_{3 \times 3} {b}_{( \cdot ) s}^{b} + {w}_{( \cdot ) s}^{b}$$

$$δ {f}^{b} = δ {b}_{a}^{b} + {w}_{a}^{b}$$

$${δω}_{b / I}^{b} = δ {b}_{g}^{b} + {w}_{g}^{b}$$

where:
(⋅)ₐ, (⋅)_{g}=accelerometer, gyro
(⋅)ₜ≡true specific force vector or angular velocity vector
M≡scale factor and non-orthogonality matrix
   b≡bias vector
b₀≡bias vector, deterministic component
bₛ≡bias vector, stochastic component
   w≡white noise vector
   τ≡correlation time.

### Navigation Filter

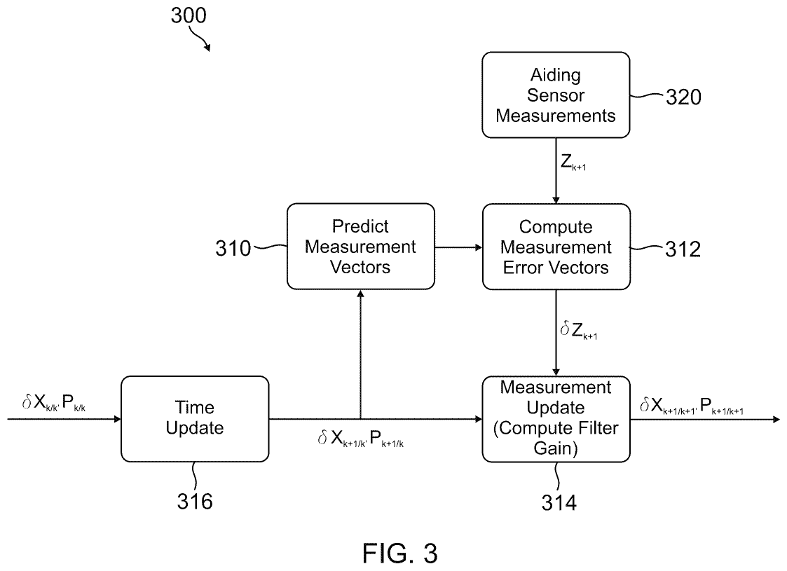

FIG. 3 is a functional block diagram of a vehicle navigation filter 300 that can be used in the present remote navigation system, according to an example embodiment. The vehicle navigation filter 300 includes a measurement prediction module 310, a measurement error module 312 in operative communication with the measurement prediction module 310, and a measurement update module 314 in operative communication with the measurement error module 312. A time update module 316 is configured to receive initial estimated vehicle kinematic state statistics (δX_{k/k}, P_{k/k}) from a strapdown INS at a first time window.

The measurement prediction module 310 is operative to predict measurement vectors after receiving updated estimated vehicle kinematic state statistics (δX_{k+1/k}, P_{k+1/k}) from the time update module 316 at a second time window. The measurement error module 312 is operative to compute measurement error vectors based on sensor measurement statistics (zₖ₊₁) from one or more aiding sensor measurements 320, and the predicted measurement vectors from the measurement prediction module 310. The measurement update module 314 is operative to compute a filter gain based on the measurement error vectors (δzₖ₊₁) from the measurement error module 312 and the updated estimated vehicle kinematic state statistics (δX_{k+1/k}, P_{k+1/k}). The measurement update module 314 is configured to output the filter updates (δX_{k+1/k+1}, P_{k+1/k+1}) for use by the strapdown INS.

### State Space Vectors

The equations utilized to define state space vectors in the present navigation system are listed as follows. For state space error vectors:

$$δ x = {[ {( δ p )}^{T} {( δ {v}^{N} )}^{T} {( {δΨ}_{b / N} )}^{T} {( {b}_{a}^{b} )}^{T} {( {b}_{g}^{b} )}^{T} ]}^{T} .$$

For process noise vectors:

$$w = {[ {0}_{1 \times 3} {( {C}_{Nb} {w}_{a}^{b} )}^{T} {( {C}_{Nb} {w}_{g}^{b} )}^{T} {( {C}_{Nb} {w}_{g}^{b} )}^{T} {( {C}_{Nb} {w}_{gs}^{b} )}^{T} ]}^{T} .$$

### Augmented State Space System

The equations utilized to define an augmented state space system in the present navigation system are listed as follows. The augmented state space system is used by the vehicle navigation filter 300.

For state vectors, a vehicle position vector relative to a map:

$${\dot{\vec{r}}}_{v , map , j} = {C}_{mapN} {\vec{v}}^{N} + {\vec{w}}_{v , map} ; j = 0$$

where:
C_{mapN}=direction cosine matrix: NED frame to map frame.
   For delayed vehicle position vectors relative to a map:

$${\dot{\vec{r}}}_{v , map , j} = \vec{0} ∀ j = 1 , … , J$$

For a sensor boresight misalignment vector:

$$\dot{\vec{s}} = {\vec{w}}_{s}$$

J≡number of past vehicle positions

$$\begin{matrix}E \{ {\vec{w}}_{v , map} ( t ) \} = \vec{0} ; E \{ {\vec{w}}_{v , map} ( t ) {\vec{w}}_{v , map}^{T} ( τ ) \} = {σ}_{v , map}^{2} {I}_{3} δ ( t - τ ) \\ E \{ {\vec{w}}_{s} ( t ) \} = \vec{0} ; E \{ {\vec{w}}_{s} ( t ) {\vec{w}}_{s}^{T} ( τ ) \} = {σ}_{s}^{2} {I}_{3} δ ( t - τ ) .\end{matrix}$$

For state error vectors:

$$\begin{matrix}δ {\dot{\vec{r}}}_{v , map} = δ {C}_{map N} {\vec{v}}^{N} + {C}_{mapN} δ {\vec{v}}^{N} + {\vec{w}}_{v , map} \\ δ {\dot{\vec{r}}}_{v , map , i} = \vec{0} \\ δ \dot{\vec{s}} = {\vec{w}}_{s} .\end{matrix}$$

For augmented state error vectors:

$$\begin{matrix}δ X = \\ [ {( δ p )}^{T} {( δ {v}^{N} )}^{T} {( {δΨ}_{b / N} )}^{T} {( {b}_{a}^{b} )}^{T} {( {b}_{g}^{b} )}^{T} {( δ {r}_{v , map}^{map} )}^{T} {( {δr}_{v , map , i}^{map} )}^{T} {( δ {s}^{b} )}^{T} ] .\end{matrix}$$

For augmented process noise vectors:

$$W = {[ {0}_{1 \times 3} {( {w}_{a}^{b} )}^{T} {( {w}_{g}^{b} )}^{T} {( {w}_{as}^{b} )}^{T} {( {w}_{gs}^{b} )}^{T} {( {w}_{v , map}^{map} )}^{T} {( {w}_{s}^{b} )}^{T} ]}^{T} .$$

For measurement vectors, the constraint equation is:

$${\vec{r}}_{v , f , i , k} = - {\vec{r}}_{v , map , j , k} + {\vec{r}}_{map , f , i , k} - \vec{s} .$$

For a map error, the feature position is:

$${\vec{p}}^{E} = {\vec{r}}_{map} + {\vec{r}}_{v , map} .$$

For a sensor measurement error:

$$\begin{matrix}{r}_{v , f , i , j , m , k}^{map} = - {r}_{v , map , j , k}^{m a p} + {r}_{v , map , f , l , j , k}^{map} - {s}^{map} + {v}_{v , f , i , j , m , k} + {\vec{v}}_{map , f , l , j , k} \\ E \{ {\vec{v}}_{v , f , i , j , k} ( t ) \} = \vec{0} ; E \{ {\vec{v}}_{v , f , i , j , k} ( t ) {\vec{v}}_{v , f , i , j , k}^{T} ( τ ) \} = {σ}_{v , f , i , j , k}^{2} δ ( t - τ ) \\ E \{ {\vec{v}}_{map , f , i , j , k} ( t ) \} = \vec{0} ; E \{ {v}_{map , f , i , j , k} ( t ) {\vec{v}}_{map , f , i , j , k}^{T} ( τ ) \} = {σ}_{map , f , i , j , k}^{2} δ ( t - τ ) \\ δ {r}_{v , f , i , j , m , k}^{map} = - δ {r}_{v , map , j , k}^{map} + δ {r}_{map , f , i , j , k}^{map} - δ {s}^{map} + {v}_{v , f , i , j , m , k} + {\vec{v}}_{map , f , i , j , k}\end{matrix}$$

subject to the constraint equation.

Note: j=0, 1, . . . , J where J is the total time of the delayed transmission from a central command (remote command center); if there is no delay, then J=0.

### Central Command-Predict Vehicle Trajectory

At a time k, the central command receives estimated kinematic state statistics from a vehicle, represented as:

$${r}_{v , k}^{N} ,$$

### P_{r,k},

$${v}_{k}^{N} ,$$

P_{v,k}, Ψ_{n/b,k}, P_{Ψ,k}. Tne central command then predicts estimated vehicle kinematic state statistics forward in time, represented as: l=1, . . . ,

$$L : {r}_{v , k + l}^{N} , {P}_{r , k + l} , {v}_{k + l}^{N} , {P}_{v , k + l} , {Ψ}_{n / b , k + l} , {P}_{Ψ , k + l}$$

where L is the map validity time.

There are many approaches known to those skilled in the art for doing this prediction step. For example, multiple approaches are found in X. Rong Li and V. P. Jilkov, “Survey of Maneuvering Target Tracking. Part I: Dynamic Models,” IEEE Transactions on Aerospace and Electronic Systems, Vol. 39, No. 4, pp. 1333-1364 October 2003, the disclosure of which is incorporated by reference herein.

The central command selects a non-maneuver dynamic model for position and velocity, and selects a white noise model for angular orientation. This results in a predicted vehicle trajectory with increasing uncertainty. For example, for an aiding sensor with a limited field of view, the predicted vehicle trajectory and its error statistics can take the shape of a conic section. As L increases, the size of the vehicle operating region increases so the vehicle can potentially observe more features, which leads to a larger map being transmitted back to the vehicle.

### Example Methodology

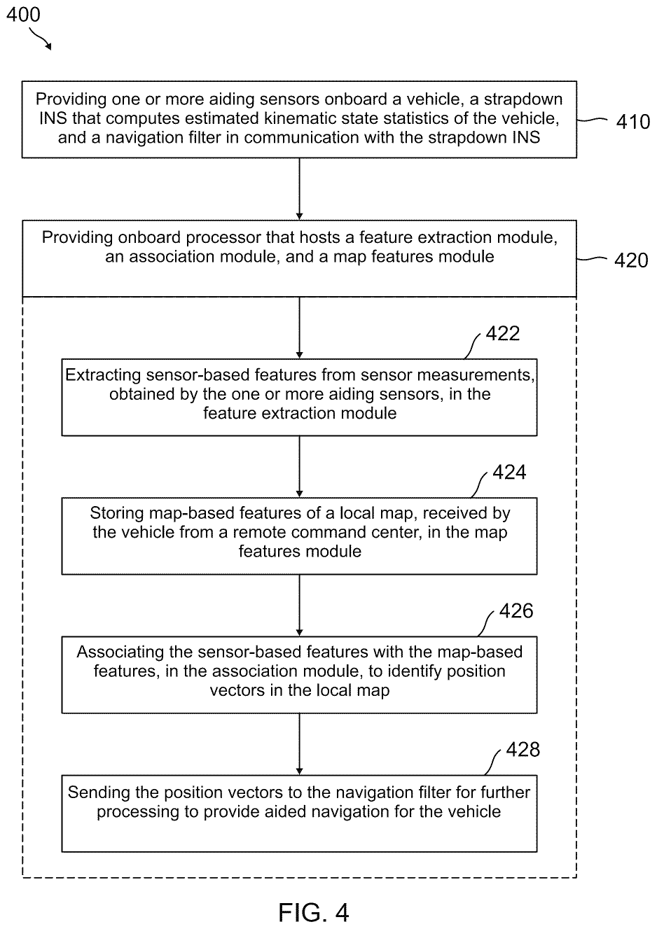

FIG. 4 is a flow diagram of a method 400 for remote navigation of a vehicle, according to one example implementation. The method 400 includes providing one or more aiding sensors onboard a vehicle, an onboard strapdown INS that computes estimated kinematic state statistics of the vehicle, and an onboard navigation filter in operative communication with the strapdown INS (block 410). The method 400 also provides at least one onboard processor that hosts a feature extraction module, an association module, and a map features module (block 420). The onboard processor performs a process that comprises extracting sensor-based features from sensor measurements, obtained by the one or more aiding sensors, in the feature extraction module (block 422); storing map-based features of a local map, received by the vehicle from a remote command center, in the map features module (block 424); associating the sensor-based features with the map-based features, in the association module, to identify position vectors in the local map (block 426); and sending the position vectors to the navigation filter for further processing to provide aided navigation for the vehicle (block 428).

The processing units and/or other computational devices used in the systems and methods described herein may be implemented using software, firmware, hardware, or appropriate combinations thereof. The processing unit and/or other computational devices may be supplemented by, or incorporated in, specially designed application-specific integrated circuits (ASICs) or field programmable gate arrays (FPGAs). In some implementations, the processing unit and/or other computational devices may communicate through an additional transceiver with other computing devices outside of the navigation system, such as those associated with a management system, or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### EXAMPLE EMBODIMENTS

Example 1 includes a system comprising: one or more aiding sensors onboard a vehicle; an inertial measurement unit (IMU) onboard the vehicle and operative to produce inertial measurements; a strapdown inertial navigation system (INS) onboard the vehicle and configured to receive the inertial measurements from the IMU, the strapdown INS configured to compute estimated kinematic state statistics of the vehicle; at least one processor operatively coupled to the one or more aiding sensors and the strapdown INS, the at least one processor hosting a feature extraction module, an association module in operative communication with the feature extraction module, and a map features module in operative communication with the association module; an onboard navigation filter in operative communication with the association module and the strapdown INS; and an onboard transmitter/receiver in operative communication with the strapdown INS; wherein the feature extraction module is operative to extract sensor-based features from sensor measurements provided by the one or more aiding sensors; wherein the map features module is operative to store map-based features of a local map received by the vehicle from a remote command center; wherein the association module is operative to associate the sensor-based features from the feature extraction module with the map-based features from the map features module to identify position vectors in the local map that are sent to the navigation filter for further processing to provide aided navigation of the vehicle.

Example 2 includes the system of Example 1, wherein the one or more aiding sensors comprise one or more: cameras, light detection and ranging (LiDAR) devices, radars, acoustic sensors, magnetometers, gravitometers, radar altimeters, star trackers, or combinations thereof.

Example 3 includes the system of any of Examples 1-2, wherein the vehicle comprises an uncrewed aircraft systems (UAS), a crewed aircraft, a ground vehicle, an underground vehicle, a water vehicle, an underwater vehicle, or a spacecraft.

Example 4 includes the system of any of Examples 1-3, wherein the navigation filter comprises: a measurement prediction module; a measurement error module in operative communication with the measurement prediction module; a measurement update module in operative communication with the measurement error module; and a time update module that is configured to receive initial estimated vehicle kinematic state statistics from the strapdown INS at a first time window.

Example 5 includes the system of Example 4, wherein: the measurement prediction module is operative to predict measurement vectors after receiving updated estimated vehicle kinematic state statistics from the time update module at a second time window; the measurement error module is operative to compute measurement error vectors based on sensor measurement statistics from one or more aiding sensor measurements, and the predicted measurement vectors from the measurement prediction module; the measurement update module is operative to compute a filter gain based on the measurement error vectors from the measurement error module and the updated estimated vehicle kinematic state statistics; and the measurement update module is configured to output filter updates for use by the strapdown INS.

Example 6 includes the system of any of Examples 1-5, wherein the remote command center comprises: a processing unit that is operative to compute the map-based features based on one or more maps stored in a local database, and periodic information received from the vehicle; and a local transmitter/receiver in operative communication with the processing unit; wherein the command center is configured to communicate with the vehicle through the local transmitter/receiver.

Example 7 includes the system of Example 6, wherein the periodic information received from the vehicle comprises the estimated kinematic state statistics of the vehicle, and sensor metadata from the one or more aiding sensors.

Example 8 includes the system of Example 7, wherein the processing unit is operative to: predict a trajectory of the vehicle forward in time to a map validity time using a computation time of the estimated kinematics state statistics as an initial time; wherein if a sensor field of view is provided in the sensor metadata, then select feature position vectors within the sensor field of view for each computed location and angular orientation and their error statistics in the predicted trajectory; wherein if a sensor field of view is not provided in the sensor metadata, then select a spherical field of view with a user selected radius, to select feature position vectors for each computed location and angular orientation and their error statistics in the predicted trajectory; remove duplicate features from the predicted trajectory when completed; and provide a local map that encompasses the predicted trajectory for transmission to the vehicle.

Example 9 includes the system of any of Examples 1-8, wherein the remote command center comprises an air traffic control system, an uncrewed air traffic management system, or a ground station.

Example 10 includes the system of any of Examples 1-8, wherein the remote command center comprises a high-altitude aircraft, a marine surface vessel, or an Earth satellite.

Example 11 includes a method comprising: providing one or more aiding sensors onboard a vehicle, an onboard strapdown inertial navigation system (INS) that computes estimated kinematic state statistics of the vehicle, and an onboard navigation filter in operative communication with the strapdown INS; and providing at least one onboard processor that hosts a feature extraction module, an association module, and a map features module, wherein the at least one onboard processor performs a process comprising: extracting sensor-based features from sensor measurements, obtained by the one or more aiding sensors, in the feature extraction module; storing map-based features of a local map, received by the vehicle from a remote command center, in the map features module; associating the sensor-based features with the map-based features, in the association module, to identify position vectors in the local map; and sending the position vectors to the navigation filter for further processing to provide aided navigation for the vehicle.

Example 12 includes the method of Example 11, wherein the one or more aiding sensors comprise one or more: cameras, light detection and ranging (LiDAR) devices, radars, acoustic sensors, magnetometers, gravitometers, radar altimeters, star trackers, or combinations thereof.

Example 13 includes the method of any of Examples 11-12, wherein the vehicle comprises an uncrewed aircraft systems (UAS), a crewed aircraft, a ground vehicle, an underground vehicle, a water vehicle, an underwater vehicle, or a spacecraft.

Example 14 includes the method of any of Examples 11-13, wherein the navigation filter comprises: a measurement prediction module; a measurement error module in operative communication with the measurement prediction module; a measurement update module in operative communication with the measurement error module; and a time update module that receives initial estimated vehicle kinematic state statistics from the strapdown INS at a first time window.

Example 15 includes the method of Example 14, wherein: the measurement prediction module performs a process comprising predicting measurement vectors after receiving updated estimated vehicle kinematic state statistics from the time update module at a second time window; the measurement error module performs a process comprising computing measurement error vectors based on sensor measurement statistics from one or more aiding sensor measurements, and the predicted measurement vectors from the measurement prediction module; and the measurement update module performs a process comprising: computing a filter gain based on the measurement error vectors from the measurement error module and the updated estimated vehicle kinematic state statistics; and outputting filter updates for use by the strapdown INS.

Example 16 includes the method of any of Examples 11-15, wherein the remote command center comprises: a processing unit that computes the map-based features based on one or more maps stored in a local database, and periodic information received from the vehicle; and a local transmitter/receiver in operative communication with the processing unit; wherein the command center communicates with the vehicle through the local transmitter/receiver.

Example 17 includes the method of Example 16, wherein the periodic information received from the vehicle comprises the estimated kinematic state statistics of the vehicle, and sensor metadata from the one or more aiding sensors.

Example 18 includes the method of Example 17, wherein the processing unit performs a process comprising: predicting a trajectory of the vehicle forward in time to a map validity time using a computation time of the estimated kinematics state statistics as an initial time; wherein if a sensor field of view is provided in the sensor metadata, then selecting feature position vectors within the sensor field of view for each computed location and angular orientation and their error statistics in the predicted trajectory; wherein if a sensor field of view is not provided in the sensor metadata, then selecting a spherical field of view with a user selected radius, to select feature position vectors for each computed location and angular orientation and their error statistics in the predicted trajectory; removing duplicate features from the predicted trajectory when completed; and providing a local map that encompasses the predicted trajectory for transmission to the vehicle.

Example 19 includes the method of any of Examples 11-18, wherein the remote command center comprises an air traffic control system, an uncrewed air traffic management system, or a ground station.

Example 20 includes the method of any of Examples 11-18, wherein the remote command center comprises a high-altitude aircraft, a marine surface vessel, or an Earth satellite.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system comprising:
one or more aiding sensors onboard a vehicle;
an inertial measurement unit (IMU) onboard the vehicle and operative to produce inertial measurements;
a strapdown inertial navigation system (INS) onboard the vehicle and configured to receive the inertial measurements from the IMU, the strapdown INS configured to compute estimated kinematic state statistics of the vehicle;
at least one processor operatively coupled to the one or more aiding sensors and the strapdown INS, the at least one processor hosting a feature extraction module, an association module in operative communication with the feature extraction module, and a map features module in operative communication with the association module;
an onboard navigation filter in operative communication with the association module and the strapdown INS; and
an onboard transmitter/receiver in operative communication with the strapdown INS;
wherein the feature extraction module is operative to extract sensor-based features from sensor measurements provided by the one or more aiding sensors;
wherein the map features module is operative to store map-based features of a local map received by the vehicle from a remote command center;
wherein the association module is operative to associate the sensor-based features from the feature extraction module with the map-based features from the map features module to identify position vectors in the local map that are sent to the navigation filter for further processing to provide aided navigation of the vehicle.

2. The system of claim 1, wherein the one or more aiding sensors comprise one or more: cameras, light detection and ranging (LiDAR) devices, radars, acoustic sensors, magnetometers, gravitometers, radar altimeters, star trackers, or combinations thereof.

3. The system of claim 1, wherein the vehicle comprises an uncrewed aircraft systems (UAS), a crewed aircraft, a ground vehicle, an underground vehicle, a water vehicle, an underwater vehicle, or a spacecraft.

4. The system of claim 1, wherein the navigation filter comprises:
a measurement prediction module;
a measurement error module in operative communication with the measurement prediction module;
a measurement update module in operative communication with the measurement error module; and
a time update module that is configured to receive initial estimated vehicle kinematic state statistics from the strapdown INS at a first time window.

5. The system of claim 4, wherein:
the measurement prediction module is operative to predict measurement vectors after receiving updated estimated vehicle kinematic state statistics from the time update module at a second time window;
the measurement error module is operative to compute measurement error vectors based on sensor measurement statistics from one or more aiding sensor measurements, and the predicted measurement vectors from the measurement prediction module;
the measurement update module is operative to compute a filter gain based on the measurement error vectors from the measurement error module and the updated estimated vehicle kinematic state statistics; and
the measurement update module is configured to output filter updates for use by the strapdown INS.

6. The system of claim 1, wherein the remote command center comprises:
a processing unit that is operative to compute the map-based features based on one or more maps stored in a local database, and periodic information received from the vehicle; and
a local transmitter/receiver in operative communication with the processing unit;
wherein the command center is configured to communicate with the vehicle through the local transmitter/receiver.

7. The system of claim 6, wherein the periodic information received from the vehicle comprises the estimated kinematic state statistics of the vehicle, and sensor metadata from the one or more aiding sensors.

8. The system of claim 7, wherein the processing unit is operative to:
predict a trajectory of the vehicle forward in time to a map validity time using a computation time of the estimated kinematics state statistics as an initial time;
wherein if a sensor field of view is provided in the sensor metadata, then select feature position vectors within the sensor field of view for each computed location and angular orientation and their error statistics in the predicted trajectory;
wherein if a sensor field of view is not provided in the sensor metadata, then select a spherical field of view with a user selected radius, to select feature position vectors for each computed location and angular orientation and their error statistics in the predicted trajectory;
remove duplicate features from the predicted trajectory when completed; and
provide a local map that encompasses the predicted trajectory for transmission to the vehicle.

9. The system of claim 1, wherein the remote command center comprises an air traffic control system, an uncrewed air traffic management system, or a ground station.

10. The system of claim 1, wherein the remote command center comprises a high-altitude aircraft, a marine surface vessel, or an Earth satellite.

11. A method comprising:
providing one or more aiding sensors onboard a vehicle, an onboard strapdown inertial navigation system (INS) that computes estimated kinematic state statistics of the vehicle, and an onboard navigation filter in operative communication with the strapdown INS; and
providing at least one onboard processor that hosts a feature extraction module, an association module, and a map features module, wherein the at least one onboard processor performs a process comprising:
extracting sensor-based features from sensor measurements, obtained by the one or more aiding sensors, in the feature extraction module;
storing map-based features of a local map, received by the vehicle from a remote command center, in the map features module;
associating the sensor-based features with the map-based features, in the association module, to identify position vectors in the local map; and
sending the position vectors to the navigation filter for further processing to provide aided navigation for the vehicle.

12. The method of claim 11, wherein the one or more aiding sensors comprise one or more: cameras, light detection and ranging (LiDAR) devices, radars, acoustic sensors, magnetometers, gravitometers, radar altimeters, star trackers, or combinations thereof.

13. The method of claim 11, wherein the vehicle comprises an uncrewed aircraft systems (UAS), a crewed aircraft, a ground vehicle, an underground vehicle, a water vehicle, an underwater vehicle, or a spacecraft.

14. The method of claim 11, wherein the navigation filter comprises:
a measurement prediction module;
a measurement error module in operative communication with the measurement prediction module;
a measurement update module in operative communication with the measurement error module; and
a time update module that receives initial estimated vehicle kinematic state statistics from the strapdown INS at a first time window.

15. The method of claim 14, wherein:
the measurement prediction module performs a process comprising predicting measurement vectors after receiving updated estimated vehicle kinematic state statistics from the time update module at a second time window;
the measurement error module performs a process comprising computing measurement error vectors based on sensor measurement statistics from one or more aiding sensor measurements, and the predicted measurement vectors from the measurement prediction module; and
the measurement update module performs a process comprising:
computing a filter gain based on the measurement error vectors from the measurement error module and the updated estimated vehicle kinematic state statistics; and
outputting filter updates for use by the strapdown INS.

16. The method of claim 11, wherein the remote command center comprises:
a processing unit that computes the map-based features based on one or more maps stored in a local database, and periodic information received from the vehicle; and
a local transmitter/receiver in operative communication with the processing unit;
wherein the command center communicates with the vehicle through the local transmitter/receiver.

17. The method of claim 16, wherein the periodic information received from the vehicle comprises the estimated kinematic state statistics of the vehicle, and sensor metadata from the one or more aiding sensors.

18. The method of claim 17, wherein the processing unit performs a process comprising:
predicting a trajectory of the vehicle forward in time to a map validity time using a computation time of the estimated kinematics state statistics as an initial time;
wherein if a sensor field of view is provided in the sensor metadata, then selecting feature position vectors within the sensor field of view for each computed location and angular orientation and their error statistics in the predicted trajectory;
wherein if a sensor field of view is not provided in the sensor metadata, then selecting a spherical field of view with a user selected radius, to select feature position vectors for each computed location and angular orientation and their error statistics in the predicted trajectory;
removing duplicate features from the predicted trajectory when completed; and
providing a local map that encompasses the predicted trajectory for transmission to the vehicle.

19. The method of claim 11, wherein the remote command center comprises an air traffic control system, an uncrewed air traffic management system, or a ground station.

20. The method of claim 11, wherein the remote command center comprises a high-altitude aircraft, a marine surface vessel, or an Earth satellite.
